(19) United States
(12) Patent Application Publication
(10) Pub. No.: US 2016/0138901 A1
(43) Pub. Date: May 19, 2016

(54) FIXTURE FOR MEASURING CENTER POSITION OF ROTATION SHAFT AND METHOD FOR MEASURING CENTER POSITION OF ROTATION SHAFT USING THE SAME

(71) Applicant: FANUC Corporation, Yamanashi (JP)

(72) Inventor: Hikaru KOSHIISHI, Yamanashi (JP)

(21) Appl. No.: 14/940,127

(22) Filed: Nov. 12, 2015

(30) Foreign Application Priority Data
Nov. 19, 2014 (JP) 2014-234601

(51) Int. Cl. G01B 5/14

(52) U.S. Cl. CPC G01B 5/14

(57) ABSTRACT

A rotation table, center position of a rotation shaft of which is to be measured, is mounted on a table of a machine tool and includes a turning plate on which a workpiece is placed, a rotary drive for rotating the turning plate, and a rotation shaft support device that is located opposite the rotary drive and supports the turning plate. A fixture, including a rod-like member that is provided with spherical reference bodies at both ends and is disposed on the turning plate of the rotary table, is used to measure the center position of the rotation shaft of the rotary table.

### RELATED APPLICATIONS

The present application claims priority to Japanese Application Number 2014-234601, filed Nov. 19, 2014, the disclosure of which is hereby incorporated by reference herein in its entirety.

### BACKGROUND OF THE INVENTION

1. Field of the Invention

The present invention relates to a fixture for measuring a center position of a rotation shaft with a turning plate mounted on a multi-axis machine tool such as a machining center and a method for measuring the center position of the rotation shaft using the fixture.

2. Description of the Related Art

In recent years, multi-axis machine tools having a rotation shaft with a turning plate have become widely used to meet customer needs such as process integration and reduction in man-hours for setup, improvement of machining accuracy, and multifaceted process. For example, a multi-axis machine tool having a rotation shaft 11 provided with a turning plate 12 and a tail support 13 such as illustrated in FIGS. 5A to 5D is used.

The multi-axis machine tool having the rotation shaft provided with the turning plate and the tail support is required to determine the rotation center position of such a rotation shaft in order to maintain machining accuracy of a workpiece.

A first method and a second method for determining a rotation center position of a rotation shaft provided with a turning plate and a tail support are described below.

Initially, the first method, which is a method for measuring the center position of the rotation shaft using no measurement fixture, is described with reference to FIGS. 5A to 5D.

One end (upper end) of the turning plate 12 is connected to the rotation shaft 11 of a rotary table and the other end (lower end) thereof is connected to the tail support 13. Y-direction position (first measurement position) of the turning plate 12 when the rotation shaft 11 is at 90 degrees (FIG. 5A) and Y-direction position (second measurement position) of the turning plate 12 when the rotation shaft 11 is at 270 degrees (FIG. 5B) are measured using a touch probe 25, and the rotation center position of the rotation shaft 11 in the Y direction is determined from the first and second measurement positions.

The touch probe 25 moves in the direction of arrows 26 in FIGS. 5A and 5B (i.e., in the measurement direction or Y direction). The rotation center position of the rotation shaft 11 in the Z direction is determined using center height 24 (FIGS. 5C and 5D), i.e., a distance in the Z direction from the surface of a base plate 17 mounted on a table 27 to the rotational center of the rotation shaft 11, the center height 24 being provided from a rotation shaft manufacturer or a machine tool manufacturer.

Next, in the second method, the rotation center position of the rotation shaft 11 in the Y direction is measured in the same manner as in the first method (FIGS. 5A and 5B) described above. On the other hand, the rotation center position of the rotation shaft 11 in the Z direction is obtained by measuring Z-direction position Z1 of the turning plate 12 when the rotational position of the rotation shaft 11 is at 0 degree, determining a distance Z2 from the center position to the turning plate 12 when the rotation center position of the rotation shaft 11 in the Y direction is measured, and determining the rotation center position of the rotation shaft 11 in the Z direction from Z1-Z2.

JP 2007-44802 A discloses another method for determining a center position of a turning shaft. This method involves a master ball mounted on a table at a predetermined position, and a turning shaft center of A-axis is referred to as A(y0, z0). The table is first turned by any turning angle β around the A-axis, and the center position c1 (cy1, cz1) of the master ball is determined with the table inclined at a turning angle β. Thereafter, the table is further turned by a predetermined angle a around the A-axis to reach a turning angle γ (i.e., γ=α+β), and the center position c2 (cy2, cz2) of the master ball is determined with the table inclined at the turning angle γ. Here, since a line obtained by turning a vector AC1 by angle α is a vector AC2, the turning shaft center A(y0, z0) is calculated.

Since it is almost impossible in the above-described two methods to install the rotation shaft and the tail support with their center positions exactly aligned, the turning plate is likely to be distorted when the turning plate is installed so that the center position of a rotation shaft cannot be measured accurately using these methods. While the center position of the rotation shaft 11 can be determined by turning the turning plate 12 and measuring the turning plate 12 directly as illustrated in FIGS. 5A and 5B, an accurate position cannot be calculated if the turning plate 12 is distorted.

When a spherical fixture such as shown in JP 2007-44802 A described above is used, a center position of the rotation shaft at an X-axis position at which actual machining is performed may be different from that at an X-axis position at which the measurement is made because a rotation shaft and a tail support are installed not necessarily completely parallel to the X-axis. That is, while the use of the spherical fixture allows the center position of the rotation shaft to be accurately determined as disclosed in JP 2007-44802 A, the center position of the rotation shaft can be measured accurately only in a location where the fixture is mounted if the rotation shaft is installed not completely parallel to any one of axes of a multi-axis machine tool. In order to address such a problem, the use of two spherical fixtures allows the inclination angle of the rotation shaft to be determined and an accurate center position of the rotation shaft could be obtained, but this is troublesome.

### SUMMARY OF THE INVENTION

Accordingly, an object of the present invention, which solves the problems of the prior art above, is to provide a fixture for measuring a center position of a rotation shaft and a method for measuring the center position of the rotation shaft using the fixture that can measure a center position of a rotation shaft accurately even if the rotation shaft is installed not completely parallel to any one of axes of a multi-axis machine tool.

The fixture of the present invention is used to measure a center position of a rotation shaft of a rotary table that is mounted on a table of a machine tool and includes a turning plate on which a workpiece is placed, a rotary drive for rotating the turning plate, and a rotation shaft support device that is located opposite the rotary drive and supports the turning plate. The fixture includes a rod-like member that is disposed on the turning plate of the rotary table and is provided with spherical reference bodies at both ends.

A method for measuring a center position of a rotation shaft according to the present invention is to measure the center position of the rotation shaft of a rotary table that is mounted on a table of a machine tool and includes a turning plate on which a workpiece is placed, a rotary drive for rotating the turning plate, and a rotation shaft support device that is located opposite the rotary drive and supports the turning plate. The method includes: a step of mounting on the rotary table a fixture for measuring the center position of the rotation shaft of the rotary table, the fixture including a rod-like member having spherical reference bodies at both ends; a step of measuring both a center position of the reference body at one end and a center position of the reference body at the other end of the rod-like member of the fixture at a plurality of rotation shaft positions using a probe attached to the machine tool; and a step of determining an inclination angle and a center position of the rotation shaft from the measured center positions of the reference bodies.

The present invention can provide the fixture for measuring the center position of the rotation shaft and the method for measuring the center position of the rotation shaft using the fixture that can measure the center position of the rotation shaft accurately even if the rotation shaft is installed not completely parallel to any one of axes of a multi-axis machine tool.

### BRIEF DESCRIPTION OF THE DRAWINGS

The above-mentioned and other objects and features of the present invention will be apparent from the following descriptions of embodiments taken in conjunction with the accompanying drawings, in which:

FIG. 1 illustrates a multi-axis machine tool equipped with a rotation shaft having a turning plate and a tail support;

FIG. 2 illustrates a fixture for measuring a center position of the rotation shaft according to the present invention, which is mounted on the turning plate;

FIGS. 3A to 3C illustrate measurements at four points for a spherical portion of the fixture in each of three orientations using the fixture illustrated in FIG. 2;

FIG. 4 is a block diagram illustrating a controller of a machine tool that is configured to measure the center position of the rotation shaft of a rotary table using the fixture illustrated in FIG. 2; and

FIGS. 5A to 5D illustrate a conventional method for measuring a center position of a rotation shaft using no measurement fixture.

### DETAILED DESCRIPTION OF THE PREFERRED EMBODIMENTS

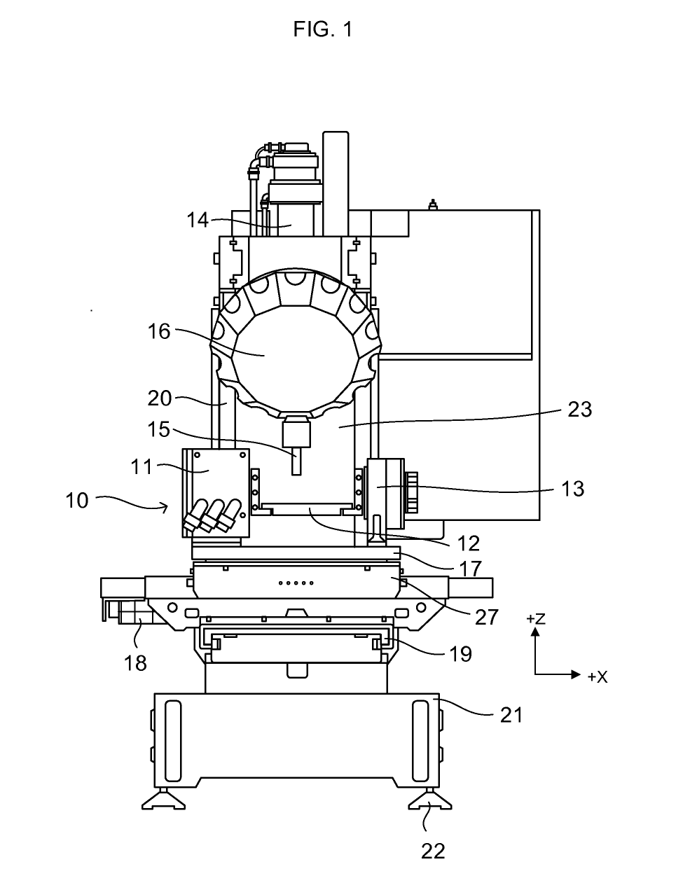

FIG. 1 illustrates a multi-axis machine tool equipped with a rotation shaft having a turning plate and a tail support.

A saddle movement mechanism, which is mounted on a bed 21 supported by legs 22, supports a Y-axis saddle 19 and drives it in the Y direction. The Y-axis saddle 19 is moved in the Y direction by a Y-axis motor (not shown). A table movement mechanism mounted on the Y-axis saddle 19 supports a table 27. The table 27 is moved in the X direction by an X-axis motor 18. The X direction is from left to right in FIG. 1 and the Y direction is perpendicular to the plane of the drawing sheet of FIG. 1.

A column 23 is erected on the bed 21 at the rear of the table 27. The upper side of the column 23 is provided with a spindle head. The spindle head is supported movably in the axial direction of a spindle (i.e., in the Z direction) through a Z-axis saddle 20 mounted on the column 23. The spindle head includes a spindle unit. The spindle unit is equipped with a spindle motor 14 for driving the spindle. The spindle of the spindle unit is provided with various tools (e.g., cutting tool 15) that are replaced by a tool magazine 16 as a tool changer. A tool (cutting tool 15) mounted on the spindle is configured to rotate along with the spindle at different rotational speeds.

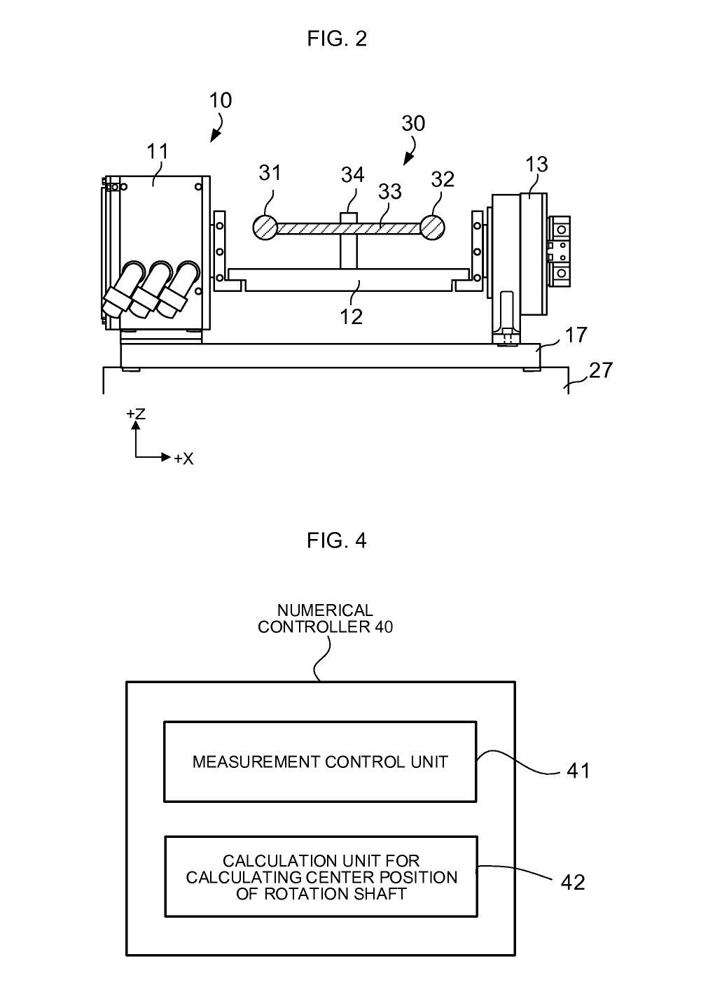

The table 27 is supported movably in two directions (X direction and Y direction) that are orthogonal to the axis of the spindle (i.e., a direction in which a Z-axis guide extends) and are orthogonal to each other. The table 27 has a rotary table 10 mounted thereon. The rotary table 10 includes a turning plate 12 for fixing a workpiece, a rotation shaft 11 for rotating the turning plate 12, a tail support 13 that is located opposite the rotation shaft 11 and supports the turning plate 12, and a base plate 17. The rotation shaft 11 and the tail support 13 are secured to the base plate 17 as illustrated in FIG. 2. The base plate 17 is secured to the table 27 as illustrated in FIG. 2. The rotation shaft 11 and the tail support 13 may be secured to the table 27 without using the base plate 17 of the rotary table 10.

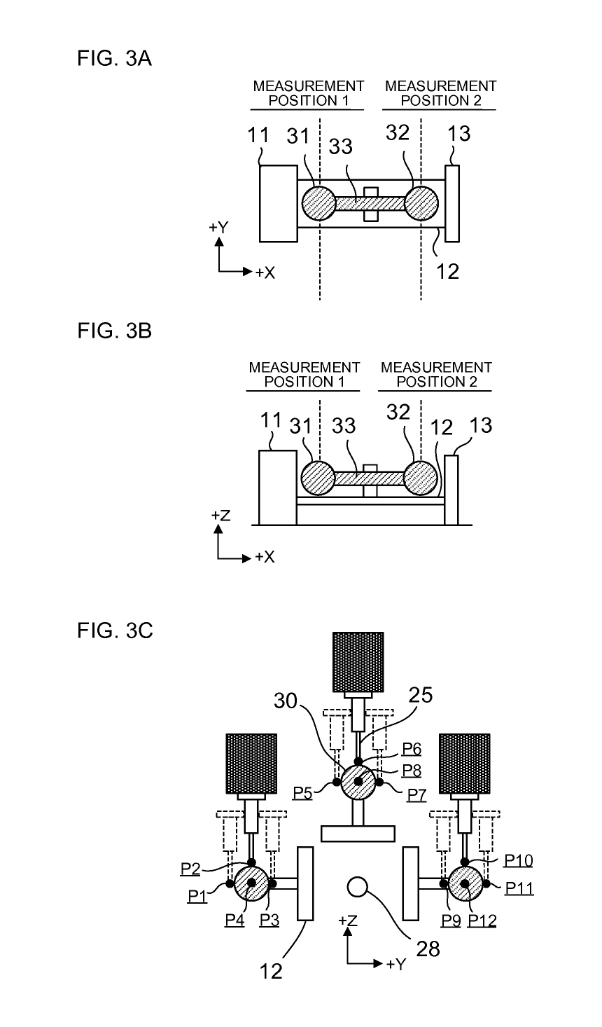

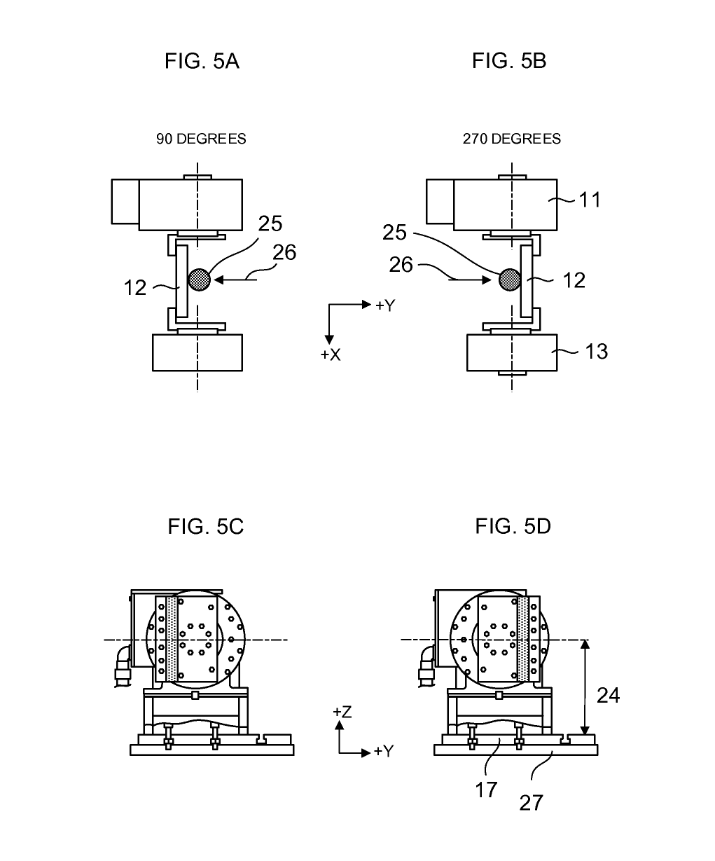

Now, in accordance with the present invention, a fixture for measuring a center position of a rotation shaft and a method for measuring the center position of the rotation shaft using the fixture that can measure a center position of a rotation shaft accurately will be described with reference to FIG. 2 and FIGS. 3A to 3C.

As illustrated in FIG. 2, a fixture 30 for measuring a center position of a rotation shaft is configured to have a rod-like member 33 having spherical members (first spherical portion 31 and second spherical portion 32) at both ends. It is described below that the fixture 30, which is mounted on the turning plate 12 of the rotary table 10, can determine the center position of the rotation shaft 11 accurately.

The fixture 30 is attached to the upper portion of a support member 34 erected on the turning plate 12 as illustrated in FIG. 2. The fixture 30 may be directly secured to the turning plate 12 by bolts or the like (not shown) without using the support member 34. The fixture 30 includes the rod-like member 33 and the first spherical portion 31 and the second spherical portion 32 provided at one end and the other end of the rod-like member 33, respectively. The first and second spherical portions 31, 32 may be formed integral with the rod-like member 33. Alternatively, the first and second spherical portions 31, 32 may be secured to the rod-like member 33 by fasteners, such as screws.

FIGS. 3A to 3C illustrates measurements at four points for each of the first and second spherical portions 31, 32 provided at both ends of the rod-like member 33 in each of three orientations described below using the fixture 30.

When the rotation shaft 11 is at three positions (orientations) of 0, 90, and 180 degrees as illustrated in FIG. 3C, the center positions of the first and second spherical portions 31, 32 at each of the three positions are measured using a touch probe 25.

Measurements are made in three orientations and at four points per orientation at two measurement positions spaced apart in the X-axis direction, i.e., “measurement position 1” and “measurement position 2” as illustrated in FIGS. 3A and 3B. This allows the center positions of the first and second spherical portions 31, 32 to be determined in each of the orientations.

That is, as illustrated in FIG. 3C,

(I) When the rotation shaft 11 is at a position of 0 degree, four points P1, P2, P3, and P4 are measured for each of the first spherical portion 31 (measurement position 1) and the second spherical portion 32 (measurement position 2).

(II) When the rotation shaft 11 is at a position of 90 degrees, four points P5, P6, P7, and P8 are measured for each of the first spherical portion 31 (measurement position 1) and the second spherical portion 32 (measurement position 2).

(III) When the rotation shaft 11 is at a position of 180 degrees, four points P9, P10, P11, and P12 are measured for each of the first spherical portion 31 (measurement position 1) and the second spherical portion 32 (measurement position 2).

The following equation (1) can be used to calculate the center position of a circle from the coordinate values of three different positions. Accordingly, among coordinate values of the four points obtained by each of the measurements (I) to (III) described above, a center position Y of a circle in the X-Y plane is calculated from three coordinate values in the X-Y plane using equation (1), and a center position Z of a circle in the Y-Z plane is calculated from three coordinate values in the Y-Z plane using equation (1). Thus, the center position of a sphere (spherical portion 31 or 32) can be determined from the center positions Y and Z of these two circles.

Y={[P1(Z)−P2(Z)]×(b-c)−[P1(Z)−P3(Z)]×d}/a

Z=−{[P1(Y)−P2(Y)]×(b-c)−[P1(Y)−P2(Y)]×d}/a (1)

where,

a=2×{[P1(Y)−P2(Y)]×[P1(Z)−P3(Z)]−[P1(Y)−P3(Y)]×[P1(Z)−P2(Z)]}

b=P3(Y)×P3(Y)+P3(Z)×P3(Z)

c=P1(Y)×P1(Y)+P1(Z)×P1(Z)

d=P2(Y)×P2(Y)+P2(Z)×P2(Z)−c

The center position of the rotation shaft 11 can be accurately determined from the obtained center positions of the first and second spherical portions 31, 32 in each of three orientations (0, 90, 180 degrees).

In addition, the inclination of the rotation shaft 11 (relative to the X-Y plane and the Z-X plane) can be determined from the center position of the first spherical portion 31 obtained by measurement at “measurement position 1” and the center position of the second spherical portion 32 obtained by measurement at “measurement position 2”. If the inclination of the rotation shaft 11 (i.e., the inclination of a rotational center 28 (FIG. 3C)) is known, rotation center positions(Y, Z) at any X-axis position can also be calculated.

These calculations automatically performed by a numerical controller allow the center position of a rotation shaft with a turning plate to be easily determined.

FIG. 4 is a block diagram illustrating a controller of a machine tool that is configured to measure the center position of the rotation shaft of the rotary table using the fixture for measuring the center position of the rotation shaft illustrated in FIG. 2.

A numerical controller 40 includes a measurement control unit 41 for performing a control for measuring a position on the surface of the spheres (spherical portions 31 and 32) in the three orientations at each of the measurement positions 1 and 2 and a calculation unit 42 for calculating a center position of a rotation shaft based on position data of the surface of the spheres measured by the measurement control unit 41 using the above-described equation (1).

Mounting both the rotation shaft and the turning plate on a multi-axis machine tool makes it difficult to attach a master bar or the like so that it is difficult for the center position of the rotation shaft to be easily and accurately determined. Since the present invention uses the fixture for measuring the center position of the rotation shaft including the rod-like member having the spherical reference bodies at both ends, the center position of the rotation shaft of the rotary table can be accurately determined.

1. A fixture for measuring a center position of a rotation shaft of a rotary table,
wherein the rotary table, mounted on a table of a machine tool, comprises a turning plate on which a workpiece is placed, a rotary drive for rotating the turning plate, and a rotation shaft support device that is located opposite the rotary drive and supports the turning plate,
and wherein the fixture comprises a rod-like member that is disposed on the turning plate of the rotary table and is provided with spherical reference bodies at both ends.

2. A method for measuring a center position of a rotation shaft of a rotary table,
wherein the rotary table, mounted on a table of a machine tool, comprises a turning plate on which a workpiece is placed, a rotary drive for rotating the turning plate, and a rotation shaft support device that is located opposite the rotary drive and supports the turning plate,
the method comprising:
mounting on the rotary table a fixture for measuring the center position of the rotation shaft of the rotary table, the fixture including a rod-like member having spherical reference bodies at both ends;
measuring both a center position of the reference body at one end and a center position of the reference body at the other end of the rod-like member of the fixture at a plurality of rotation shaft positions using a probe attached to the machine tool; and
determining an inclination angle and a center position of the rotation shaft from the measured center positions of the reference bodies.
